(19) United States
(12) Patent Application Publication
(10) Pub. No.: US 2023/0051402 A1
(43) Pub. Date: Feb. 16, 2023

(54) CONTROL APPARATUS AND CONTROL METHOD FOR COMMUNICATION DEVICE

(71) Applicant: NEC Corporation, Tokyo (JP)

(72) Inventor: Eriko SAEKI, Tokyo (JP)

(73) Assignee: NEC Corporation, Tokyo (JP)

(21) Appl. No.: 17/873,305

(22) Filed: Jul. 26, 2022

(30) Foreign Application Priority Data
Aug. 11, 2021 (JP) 2021-131211

(51) Int. Cl. H04W 52/02; H04L 1/00

(52) U.S. Cl. CPC H04W 52/0212; H04W 52/0274; H04L 1/0003

(57) ABSTRACT

A control apparatus for a communication device includes: a data acquisition unit that acquires data regarding a use condition of a communication device to be monitored from the communication device; a data analysis unit that analyzes the use condition of the communication device to be monitored based on the acquired data regarding the use condition of the communication device; and a device control unit that controls the communication device to be monitored to shift between a normal mode and a power saving mode based on a result of the analysis by the data analysis unit.

This application is based upon and claims the benefit of priority from Japanese Patent Application No. 2021-131211, filed on Aug. 11, 2021, the disclosure of which is incorporated herein in its entirety by reference.

### TECHNICAL FIELD

The present invention relates to a control apparatus and a control method for a communication device, and particularly relates to power control of a wireless transmission apparatus included in a communication network.

### BACKGROUND ART

Various element management systems (EMSs) that manage network devices (for example, wireless transmission devices) included in a communication network and various network management systems (NMSs) that perform maintenance management related to network traffic and security have been proposed.

Japanese Patent Application Laid-open No. 2016-66934 (JP2016-66934A) relates to control of an adaptive modulation scheme of wireless communication, and it is proposed to dynamically change a modulation scheme in response to a change in line quality of a wireless communication line caused by weather or fading. In JP2016-66934A, it is proposed to determine a modulation scheme that enables communication with less output power as a modulation scheme for performing communication with an opposing device.

Japanese Patent Application Laid-open No. 2014-67157 (JP2014-67157A) relates to a wireless communication terminal, and it is proposed to perform communication with another wireless communication terminal by switching between a normal mode in which power supply is performed by the amount of power that enables data communication with the another wireless communication terminal and a power saving mode in which power supply is performed by the amount of power smaller than the amount of power by which the power supply is performed in the normal mode.

Japanese Patent Application Laid-open No. 2003-263251 (JP2003-263251A) relates to an information processing apparatus having a wireless communication function, and it is proposed to suspend a function of an information processing unit in a state in which a function of a wireless communication unit is operated to shift the operation state of the information processing unit to a low power consumption mode when there is no change in a state of the information processing unit for a certain period of time.

In a communication network including a plurality of network elements (NEs), it is desirable that transmission power of the NEs be set to an appropriate value between the NEs in accordance with a use condition of communication. As the NE, an NE supporting automatic transmission power control has been proposed. With the NEs supporting the automatic transmission power control, appropriate transmission power can be set between the NEs. On the other hand, there are also NEs that do not support such a function, and it is necessary to set transmission power values for the NEs that do not support the function one by one by a user operation.

In a case where appropriate transmission power is to be set by the user operation, it is difficult to frequently change the setting, and the setting corresponding to a communication use condition is difficult.

JP2016-66934A, JP2014-67157A, and JP2003-263251A do not propose an implementation means configured to set appropriate transmission power in accordance with a communication use condition.

The present invention has been made in view of such circumstances, and an object of the present invention is to provide a control apparatus and a control method for a communication device which enable a shift of the communication device between a normal mode and a power saving mode in accordance with a use condition of the communication device.

### SUMMARY

In order to achieve the above object, a control apparatus for a communication device according to the present invention includes:

a data acquisition unit that acquires data regarding a use condition of a communication device to be monitored from the communication device;

a data analysis unit that analyzes the use condition of the communication device to be monitored based on the acquired data regarding the use condition of the communication device; and

a device control unit that controls the communication device to be monitored to shift between a normal mode and a power saving mode based on a result of the analysis by the data analysis unit.

A communication system according to the present invention includes:

the above-described control apparatus for a communication device; and

a communication device monitored by the control apparatus for a communication device.

A control method for a communication device according to the present invention includes:

acquiring data regarding a use condition of a communication device to be monitored from the communication device;

analyzing the use condition of the communication device to be monitored based on the acquired data regarding the use condition of the communication device; and

controlling the communication device to be monitored to shift between a normal mode and a power saving mode based on an analysis result of the use condition.

A control program for a communication device according to the present invention that causes a computer to execute:

data acquisition processing of acquiring data regarding a use condition of a communication device to be monitored from the communication device;

data analysis processing of analyzing the use condition of the communication device to be monitored based on the acquired data regarding the use condition of the communication device; and

device control processing of controlling the communication device to be monitored to shift between a normal mode and a power saving mode based on an analysis result obtained by the data analysis processing.

According to the present invention, it is possible to provide the control apparatus and the control method for a communication device which enable the shift of the communication device between the normal mode and the power saving mode in accordance with the use condition of the communication device.

### BRIEF DESCRIPTION OF THE DRAWINGS

Exemplary features and advantages of the present invention will become apparent from the following detailed description when taken with the accompanying drawings in which:

FIG. 1 is a block diagram for describing a communication device management apparatus to which a control apparatus for a communication device according to an example embodiment of a superordinate concept of the present invention is applied;

FIG. 2 is a configuration diagram for describing a communication system including the communication device to which the control apparatus and a control method for a communication device according to the example embodiment of the present invention are applied;

FIG. 3 is a block diagram for describing an example of a configuration of an EMS/NMS in FIG. 2;

FIG. 4 is a sequence chart for describing an operation of a control apparatus for a communication device according to a first example embodiment of the present invention;

FIG. 5 is a conceptual diagram for describing a display example of an analysis result obtained by the EMS/NMS according to the example embodiment of the present invention;

FIG. 6 is a sequence chart for describing a modified example of the operation of the control apparatus for a communication device according to the first example embodiment of the present invention;

FIG. 7A is a block diagram for describing an information processing apparatus constituting a control apparatus for a communication device according to another example embodiment of the present invention; and

FIG. 7B is a block diagram for describing processing executed by the information processing apparatus in FIG. 7A.

### EXAMPLE EMBODIMENT

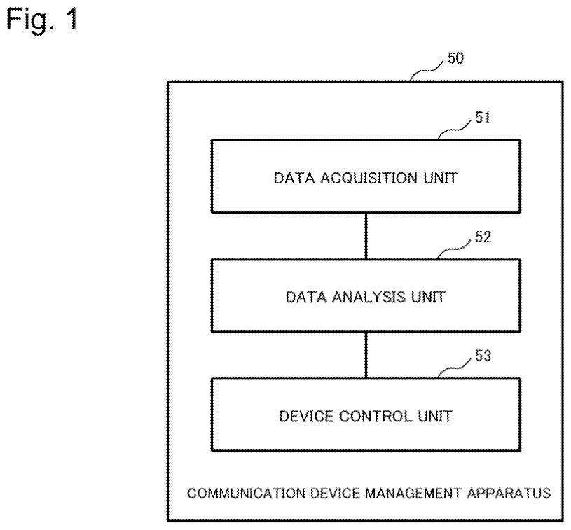

A control apparatus and a control method for a communication device according to an example embodiment of a superordinate concept of the present invention will be described. FIG. 1 is a block diagram for describing a communication device management apparatus to which the control apparatus for a communication device according to the example embodiment of the superordinate concept of the present invention is applied.

A communication device management apparatus 50 in FIG. 1 includes a data acquisition unit 51, a data analysis unit 52, and a device control unit 53. The communication device management apparatus 50 manages communication devices included in a communication system. The data acquisition unit 51 acquires, from communication devices to be monitored, pieces of data regarding use conditions of the communication devices, for example, communication use conditions. The communication devices to be monitored are included in the communication system. For example, the data acquisition unit 51 acquires pieces of data regarding communication conditions of the communication devices from the communication devices to be monitored at regular intervals. The data analysis unit 52 analyzes the use conditions of the communication devices to be monitored, for example, the communication use conditions, on the basis of pieces of the acquired data regarding the use conditions of the communication devices. For example, the data analysis unit 52 identifies a communication device with a low frequency of use among the communication devices to be monitored, and identifies a time zone with a low frequency of use for a certain communication device to be monitored. The device control unit 53 controls the communication device to be monitored to shift between a normal mode and a power saving mode based on an analysis result obtained by the data analysis unit 52. Here, the power saving mode refers to, for example, a state in which transmission power of the communication device is lower than transmission power in the normal mode. For example, the communication device for which the time zone with the low frequency of use has been identified by the analysis result of the data analysis unit 52, the device control unit 53 controls the communication device to shift to the power saving mode in the time zone with the low frequency of use.

According to the communication device management apparatus 50 in FIG. 1, the data regarding the use condition of the communication device is acquired from the communication device to be monitored, the use condition of the communication device to be monitored is analyzed on the basis of the acquired data regarding the use condition of the communication device, and the communication device to be monitored is controlled to shift between the normal mode and the power saving mode based on the analysis result. As a result, the communication device can be shifted between the normal mode and the power saving mode in accordance with the use condition of the communication device.

For example, when the communication device with the low frequency of use has been identified among the communication devices to be monitored, power consumption of the communication device can be reduced by controlling the communication device to shift from the normal mode to the power saving mode. For example, when the time zone with the low frequency of use has been identified for the certain communication device to be monitored, power consumption of the communication device can be reduced by controlling the communication device to shift from the normal mode to the power saving mode in the time zone with the low frequency of use. Hereinafter, preferred example embodiments of the present invention will be described in detail with reference to the drawings.

### First Example Embodiment

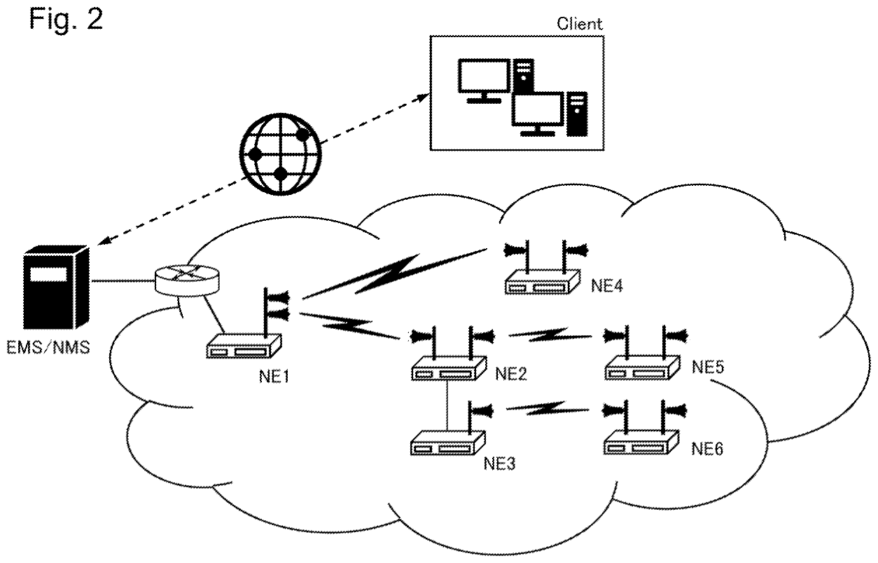

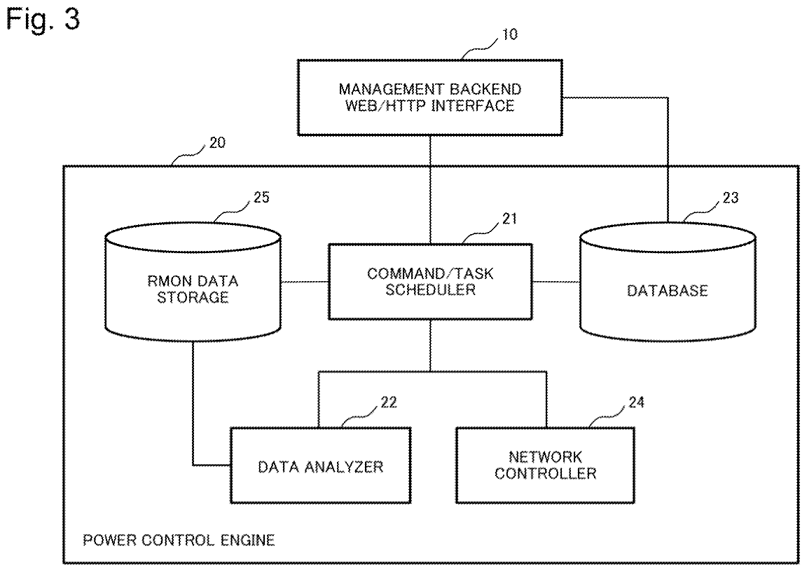

Next, a control apparatus and a control method for a communication device according to a first example embodiment of the present invention will be described. FIG. 2 is a configuration diagram for describing a communication system including a communication device to which the control apparatus and the control method for a communication device according to the example embodiment of the present invention are applied. FIG. 3 is a block diagram for describing an example of a configuration of an EMS/NMS of FIG. 2.

(Configuration of Example Embodiment)

The communication system in FIG. 2 includes: a network element (NE) as an example of the communication device; an element management system (EMS) that manages the NE; a network management system (NMS) that performs maintenance management related to network traffic and security in addition to the network device; and a client. The element management system that manages the NE and the network management system that performs the maintenance management related to the network traffic and security in addition to the network device are referred to as the EMS/NMS. Note that FIG. 2 illustrates a case where the communication system is a wireless network and includes a plurality of the NEs (NE1 to NE6).

The EMS/NMS performs failure management, configuration management, accounting management, performance management, and confidentiality management of the communication system in FIG. 2. The client receives an input from a user and displays a network condition or the like. The NE is connected to another NE in a wired or wireless manner to transmit information. FIG. 2 illustrates, as an example, a state in which a wireless connection is established between the NE1 and the NE2, between the NE1 and the NE4, between the NE2 and the NE5, and between the NE3 and the NE6, and a wired connection is established between the NE2 and the NE3.

As illustrated in FIG. 3, the EMS/NMS of FIG. 2 includes a management backend 10 and a power control engine 20. The management backend 10 includes, for example, a WEB/HTTP interface (Web/Hypertext Transfer Protocol interface) to receive an input from a user. Then, the management backend 10 receives the input from the user and displays a processing result.

The power control engine 20 of FIG. 3 performs processes related to the example embodiment of the present invention. The power control engine 20 of FIG. 3 includes a command/task scheduler 21, a data analyzer 22 as an example of a data analysis unit, and a database 23. The power control engine 20 further includes a network controller 24 as an example of a data acquisition unit and a device control unit, and a remote network monitoring data storage 25 (RMON data storage 25).

The command/task scheduler 21 performs the overall control of the power control engine 20. In the database 23, all the processes performed by the power control engine 20 and results thereof are stored. The network controller 24 acquires remote network monitoring data (RMON data) as an example of data regarding a communication condition of the communication device from the NE to be monitored in accordance with an instruction from the command/task scheduler 21.

The RMON data includes information on the amount of communication between the NEs on the network, and it is possible to grasp a use condition and optimize a network configuration by analyzing the RMON data. Then, the network controller 24 stores the acquired RMON data in the RMON data storage 25. The network controller 24 receives a simple network management protocol trap (SNMP trap) from the NE, reads a network topology, and receives an alert from the NE.

The data analyzer 22 analyzes use conditions of the NEs per time zone from pieces of data of the RMON data storage 25 in accordance with an instruction of the command/task scheduler 21, and stores analyzed results in the database 23.

(Operation of Example Embodiment)

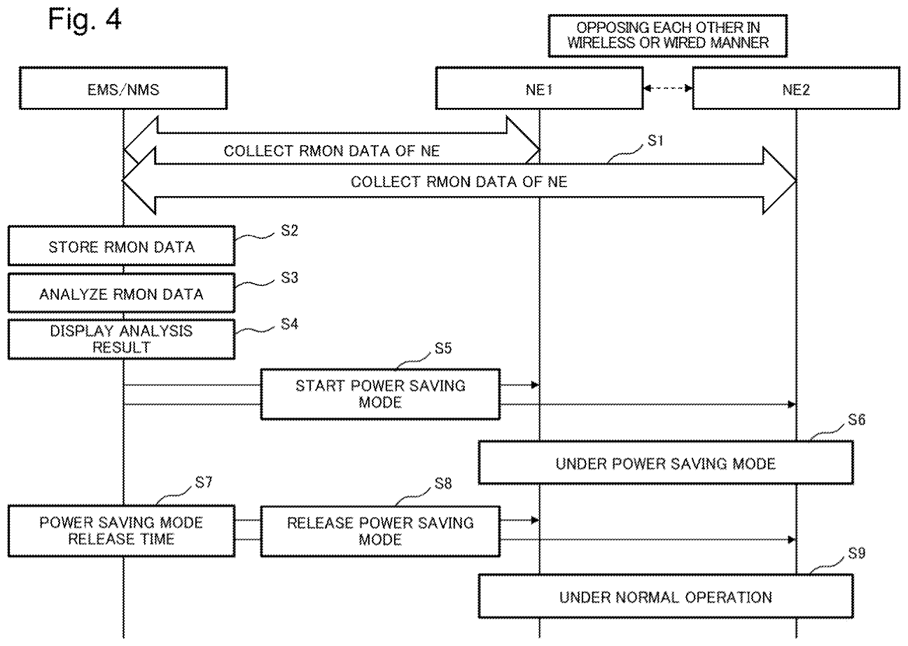

Next, an operation of the control apparatus for a communication device and the control method for a communication device according to the present example embodiment will be described with reference to FIG. 4. FIG. 4 illustrates an operation of starting the power saving mode and an operation of releasing the power saving mode for an NE in a normal operation state (the normal mode). In FIG. 4, a description is given by exemplifying the operations for the EMS/NMS and the NE1 and the NE2 opposing each other in a wireless or wired manner which are included in the wireless network as an example of the communication system.

The network controller 24 of the EMS/NMS collects RMON data of NEs to be monitored (the NE1 and the NE2) (S1). This RMON data collection is executed by acquiring the RMON data from the NEs to be monitored (the NE1 and the NE2) at predetermined intervals.

The command/task scheduler 21 stores the collected RMON data of the NEs to be monitored (the NE1 and the NE2) in the RMON data storage 25 (S2).

The data analyzer 22 analyzes the RMON data stored in the RMON data storage 25 (S3). More specifically, the data analyzer 22 extracts an NE with a low frequency of use and extracts a time zone with a low frequency of use for an NE, and displays the extracted result on a screen (S4). This screen display will be described later with an example in (Display of Analysis Result). The data analyzer 22 confirms an error rate in the RMON data, and determines a modulation scheme and/or transmission power of the NE and based on a result of the confirmation.

When the modulation scheme and/or the transmission power of the NE are determined, the power saving mode is set in the time zone with the low frequency of use, and a threshold for the error rate is set to be higher than that in the normal operation state. In other words, even if there are many errors, the errors are permitted under the power saving mode of the NE. The data analyzer 22 updates the analysis result each time new RMON data is acquired. Thus, the analysis of the data analyzer 22 can follow a change in the use condition of the NE to be monitored.

For example, when at least one of the NE1 and the NE2 among the NEs to be monitored is extracted as the NE with the low frequency of use or the time zone with the low frequency of use is extracted for at least one of the NE1 and the NE2, the network controller 24 instructs the NE to start the power saving mode (S5). Here, a description will be given assuming that the start of the power saving mode and the release of the power saving mode are controlled by time.

At a power saving mode start time, the network controller 24 requests each of the NEs to start the power saving mode, and controls the modulation scheme and/or the transmission power of the NE. Since the NE1 and the NE2 oppose each other in a wireless or wired manner in the case of FIG. 4, when instructing the NE1 to start the power saving mode, for example, the network controller 24 also instructs the NE2 on the opposing side to start the power saving mode at the same time. When instructing the NE2 to start the power saving mode, the network controller 24 also instructs the NE1 on the opposing side to start the power saving mode at the same time. An instruction is further given to the NE1 and the NE2 to set the threshold for the error rate to be higher than a normal value.

In response to the instruction from the network controller 24, the NE1 and the NE2 are set to the power saving mode (S6).

Next, the network controller 24 confirms arrival of a power saving mode release time (S7). The network controller 24 requests the NEs to release the power saving mode at the power saving mode release time (S8). At this time, the network controller 24 instructs each of the NEs to return the threshold for the error rate to the normal value. Since the NE1 and the NE2 oppose each other in a wireless or wired manner in the case of FIG. 4, when instructing the NE1 to release the power saving mode, for example, the network controller 24 also instructs the NE2 on the opposing side to release the power saving mode at the same time. When instructing the NE2 to release the power saving mode, the network controller 24 also instructs the NE1 on the opposing side to release the power saving mode at the same time.

In response to the instruction from the network controller 24, the NE1 and the NE2 release the power saving mode and return to the normal operation (S9). In response to the instruction from the network controller 24 to return the threshold for the error rate to the normal value for each of the NEs, each of the NEs returns the threshold for the error rate to the normal value and restarts the normal operation.

(Display of Analysis Result)

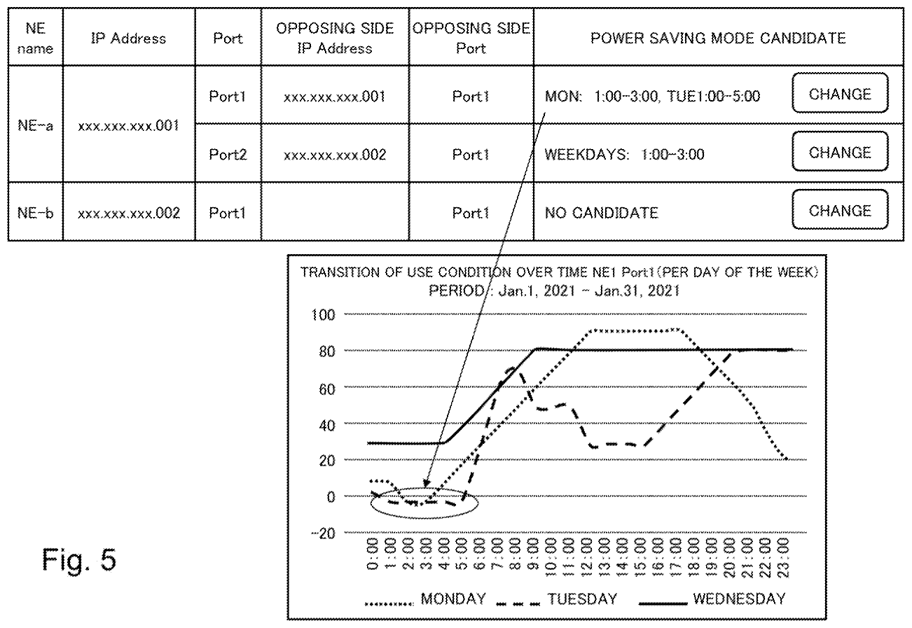

An example of the screen display based on an analysis result obtained by the data analyzer 22 will be described. FIG. 5 is a conceptual diagram for describing a display example of an analysis result of the EMS/NMS according to the example embodiment of the present invention, and illustrates an example of a case where an analysis result obtained by the data analyzer 22 is displayed on a screen of the EMS/NMS. A gist of the present invention is to apply the power saving mode to the NE without the user operation, but the analysis result may be displayed for the user.

For example, among the NEs to be monitored by the EMS and/or the NMS, a list of NEs to which the power saving mode is applicable is displayed, and candidates for a power saving mode setting time are displayed. The example of FIG. 5 illustrates a case where, as the NE to which the power saving mode is applicable, NE-a and NE-b list “power saving mode candidates” as Port, opposite-side Port, and a day of the week or a time zone in which the power saving mode is set.

The “power saving mode candidates” in the list display are derived from pieces of data of time transition of a use condition of Port 1 of the NEs per day of the week illustrated in a lower view of FIG. 5. In the lower view of FIG. 5, as an example, the time transition of the use condition for one day on Monday, Tuesday, and Wednesday from Jan. 1, 2021 to Jan. 31, 2021 is illustrated per day of the week. From the data of the temporal transition of the use condition of Port 1 of the NEs per day of the week, regarding Port 1 of NE-a, 1:00 to 3:00 on Monday and 1:00 to 5:00 on Tuesday, which are days of the week and time zones when the frequency of use is low, are displayed as the “power saving mode candidates”.

In this manner, the list of the NEs to which the power saving mode is applicable is displayed, and the candidates for the setting time when the power saving mode is set are displayed. Although the transition of Port 1 of NE-a per day of the week is displayed in the lower view of FIG. 5, data of a specific day can be also displayed on a monthly basis or on a yearly basis.

The user can also confirm transition of past use conditions of NEs to determine an NE to which the power saving mode is set and change a setting regarding the setting of the power saving mode.

(Modified Example of Operation of Example Embodiment)

Although the operation of setting the threshold for the error rate of the NE to be high and controlling the modulation scheme and/or the transmission power of the NE until the EMS/NMS releases the setting under the power saving mode has been described in FIG. 4 described above, the present example embodiment is not limited to this control.

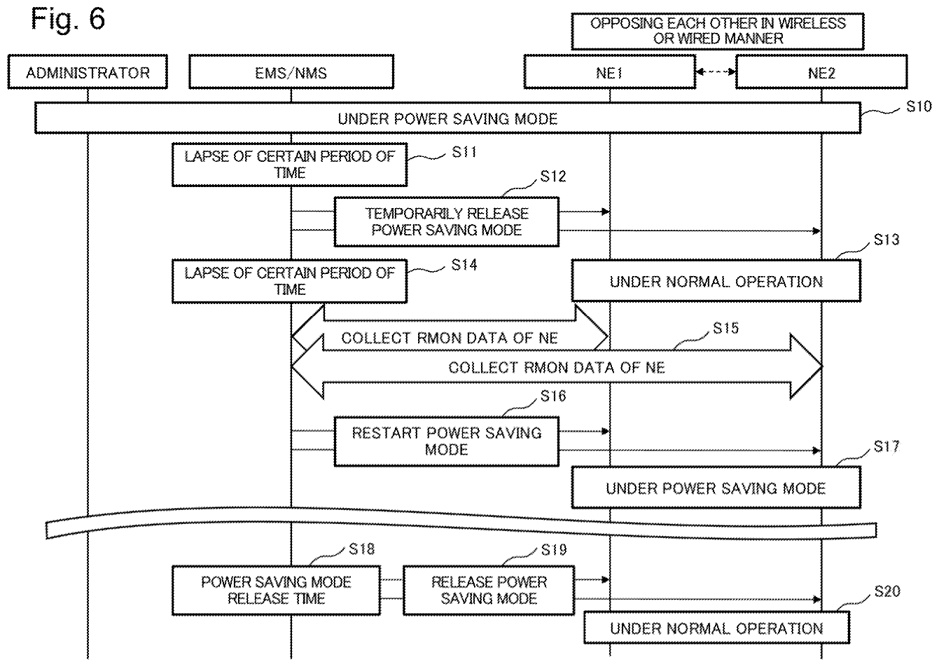

For example, an operation of temporarily releasing the power saving mode to return to the normal operation state and starting the power saving mode again may be performed. FIG. 6 is a sequence chart for describing a modified example of the operation of the control apparatus for a communication device according to the first example embodiment of the present invention. In FIG. 6, a description is given by exemplifying the operations for the EMS/NMS and the NE1 and the NE2 wirelessly opposing each other which are included in a wireless network.

First, the NE1 and the NE2 are set to the power saving mode (S10). A setting of a period of time for which the power saving mode is maintained can be changed. The network controller 24 confirms a lapse of a certain period of time (S11). After the lapse of the certain period of time, the network controller 24 requests the NEs to temporarily release the power saving mode (S12). In response to the instruction from the network controller 24, the NE1 and the NE2 temporarily release the power saving mode and are set to the normal operation (S13). The NE1 and the NE2 return thresholds for error rates to normal values and restart the normal operation.

Subsequently, the network controller 24 confirms that a period of time for which the NEs to be monitored maintain the normal operation state has passed a certain period of time (S14). This period of time for which the normal operation state is maintained can be set. After a lapse of the certain period of time, the network controller 24 measures real-time data of remote network monitoring (RMON). In other words, the network controller 24 confirms the RMON real-time data for the NEs to be monitored (S15).

Next, the network controller 24 confirms that no data flows as a result of the confirmation of the RMON real-time data, and then, requests the NEs to restart the power saving mode again. In other words, the network controller 24 instructs the NEs to be monitored to restart the power saving mode after confirming that no data flows (S16). In response to the instructions from the network controller 24, the NE1 and the NE2 return to the power saving mode and are set to the power saving mode (S17). In this manner, it is conceivable to perform processing of repeating S11 to S17 in FIG. 6 on the NE under the power saving mode. In other words, it is conceivable that the network controller 24 temporarily releases the power saving mode and determines whether to continue the power saving mode even before reaching the power saving mode release time.

In this manner, it is also conceivable to temporarily release the power saving mode for the NE under the power saving mode, confirm a use condition of the NE in real time, and determine whether to continue the power saving mode. For example, it is possible to give an instruction for restarting the power saving mode to the NE for which it has been confirmed that no data flows as a result of the confirmation of the use condition of the NE in real time, and return the NE to the power saving mode. It is possible to give an instruction for a shift to the normal mode that is not temporary but continuous to the NE for which it has been confirmed that data flows as a result of the confirmation of the use condition of the NE in real time.

Thereafter, the network controller 24 confirms arrival of the power saving mode release time (S18), and requests the NEs to release the power saving mode when the power saving mode release time arrives (S19). In response to the instruction from the network controller 24, the NE1 and the NE2 release the power saving mode and return to the normal operation (S20).

(Advantageous Effects of Example Embodiment)

According to the control apparatus and the control method for a communication device of the present example embodiment, the data regarding the use condition of the NE is acquired from the NE to be monitored, the use condition of the NE to be monitored is analyzed on the basis of the acquired data regarding the use condition of the NE, and the NE to be monitored is controlled to shift between the normal mode and the power saving mode based on the analysis result. Accordingly, the following advantageous effects are obtained.

A first advantageous effect is that the NE can be shifted between the normal mode and the power saving mode in accordance with the use condition of the NE, and all processes required for this control can be performed by the EMS/NMS, and thus, it is unnecessary to change control software in the NE.

Since all the processes required for the control can be performed by the EMS/NMS in this manner, the control can be achieved only by the operation through the EMS/NMS without changing the control software in the NE. Accordingly, the present example embodiment can be applied to the NE in operation without changing or replacing software.

In particular, the power consumption of the NE can be reduced by shifting the NE between the normal mode and the power saving mode in accordance with the communication condition of the NE, and it is possible to reduce the power consumption particularly related to a wireless communication portion of the NE.

A second advantageous effect is that it is possible to provide the start of the power saving mode and the release of the power saving mode in accordance with the use condition of the NE even if the NE to be monitored, which is included in the communication system, is an NE that does not support transmission power control since all the processes required for the control can be performed by the EMS/NMS.

A third advantageous effect is that the control for shifting the NE between the normal mode and the power saving mode can be collectively performed on all the NEs in the network by performing the setting in the EMS/NMS. As a result, no special configuration or processing is required on the NE side. As a result, the EMS/NMS automatically performs a setting suitable for a communication use condition or changes the setting without requiring a change in the setting, such as setting of appropriate transmission power, performed by the user operation.

A fourth advantageous effect is that it is possible to follow a change in the use condition of the NE by acquiring the RMON data as the data regarding the use condition from the NE to be monitored at regular intervals, continuing the analysis of the RMON data, and continuing to update the analysis result of the RMON data.

A fifth advantageous effect is that power consumption of an NE can be reduced by controlling the NE to shift to the power saving mode in which the transmission power is lower than the transmission power in the normal mode or the modulation scheme is different from the modulation scheme in the normal mode for the NE with the low frequency of use or the time zone in which the frequency of use of the NE is low among the NEs to be monitored.

### Second Example Embodiment

Next, a control apparatus and a control method for a communication device according to a second example embodiment of the present invention will be described. In the present example embodiment, the control method is different although a configuration similar to that of the control apparatus for a communication device according to the first example embodiment is used. In other words, the basic configuration is similar to that of the control apparatus and the control method for a communication device according to the first example embodiment described above, but may be as follows.

Firstly, when data arrives at an NE under a power saving mode, the NE may voluntarily release the power saving mode and return to a normal operation state (normal mode). In other words, the NE may be configured such that the NE voluntarily releases the power saving mode and returns to the normal operation state (normal mode) when data arrives at the NE under the power saving mode.

Secondly, there may be a case where it is difficult to maintain a connection with an NE on the opposing side due to transmission power of an NE set to be low, and thus, a path may be reset simultaneously with provision of a power saving setting that utilizes a shift from the normal mode to the power saving mode according to the example embodiment of the present invention.

Thirdly, the control according to the example embodiment of the present invention can also be applied to an NE that supports transmission power control. The NE that supports the transmission power control can set the optimum transmission power between NEs, and it is possible to provide the power saving setting more suitable for a use condition by analyzing a time zone when an NE is not used and applying the power saving mode by the above-described processing of the example embodiment of the present invention.

Fourthly, in a case of configuring Radio Traffic Aggregation (RTA: a technology of performing packet transfer by using a plurality of radio channels virtually as one physical layer) or Link Aggregation Group (LAG: a technology of virtually bundling and transmitting a plurality of wired local area networks (LANs)), a part of ports constituting the RTA or the LAG can be set to a transmission power-off state (set not to perform transmission) only in a time zone when the frequency of use is low. For example, in a case where the RTA is constituted by Port 1 and Port 2 in the NEs, it is also possible to perform such control as to turn off transmission power of Port 2.

### Another Example Embodiment

The control apparatus for a communication device according to each of the example embodiments of the present invention described above can also be achieved by an information processing apparatus capable of executing a program that implements such a configuration and operation. The program can be distributed in a form of a computer-readable recording medium. The program recorded in such a recording medium may be read and executed by the information processing apparatus to implement functions of the present example embodiments in a software manner.

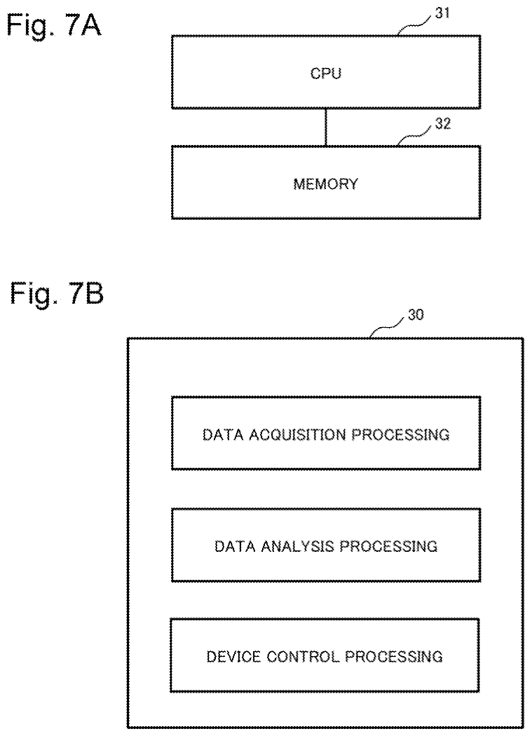

FIG. 7A is a block diagram for describing the information processing apparatus that forms a control apparatus for a communication device according to another example embodiment of the present invention, and FIG. 7B is a block diagram for describing processing executed by the information processing apparatus of FIG. 7A.

The information processing apparatus in FIG. 7A includes a central processing unit (CPU) 31 and a memory 32. The control apparatuses for a communication device according to the example embodiments of the present invention described above can be achieved by the information processing apparatus having such a configuration. That is, the CPU 31 may be configured to read the program to execute data acquisition processing, data analysis processing, and device control processing in FIG. 7B.

In the data acquisition processing, pieces of data regarding a use conditions of communication devices to be monitored, which are included in a communication system, for example, communication use conditions, are acquired from the communication devices. For example, in the data acquisition processing, pieces of data regarding communication conditions of the communication devices are acquired from the communication devices to be monitored at regular intervals.

In the data analysis processing, the use conditions of the communication devices to be monitored, for example, the communication use conditions, are analyzed on the basis of pieces of the acquired data regarding the use conditions of the communication devices. In the data analysis processing, for example, a communication device with a low frequency of use is identified among the communication devices to be monitored, and a time zone with a low frequency of use is identified for a certain communication device.

In the device control processing, the communication device to be monitored is controlled to shift between a normal mode and a power saving mode based on an analysis result of the data analysis processing.

The program for executing such processing can be distributed in a form of a recording medium in which the program is recorded. This program can be distributed in a form of a general-purpose semiconductor recording device such as CompactFlash (CF) (Registered Trademark) and Secure Digital (SD), a magnetic recording medium such as a flexible disk, an optical recording medium such as a compact disc read only memory (CD-ROM), or the like.

Although the preferred example embodiments of the present invention have been described as above, the present invention is not limited thereto. Various modifications can be made within the scope of the invention described in the claims, and it goes without saying that these are also included in the scope of the present invention.

The whole or part of the example embodiments disclosed above can be described as, but not limited to, the following supplementary notes.

(Supplementary Note 1)

A control apparatus for a communication device, including:

a data acquisition unit that acquires data regarding a use condition of a communication device to be monitored from the communication device;

a data analysis unit that analyzes the use condition of the communication device to be monitored based on the acquired data regarding the use condition of the communication device; and

a device control unit that controls the communication device to be monitored to shift between a normal mode and a power saving mode based on an analysis result obtained by the data analysis unit.

(Supplementary Note 2)

The control apparatus for a communication device according to Supplementary Note 1, wherein

the communication device to be monitored is controlled in the power saving mode in such a way that transmission power is lower than transmission power in the normal mode.

(Supplementary Note 3)

The control apparatus for a communication device according to Supplementary Note 1 or 2, wherein

the communication device to be monitored is controlled in the power saving mode in such a way as to adopt a modulation scheme different from a modulation scheme of communication in the normal mode.

(Supplementary Note 4)

The control apparatus for a communication device according to any one of Supplementary Notes 1 to 3, wherein

the communication device to be monitored is controlled in the power saving mode in such a way as to turn off transmission power of one communication port out of a plurality of communication ports provided in the communication device.

(Supplementary Note 5)

The control apparatus for a communication device according to any one of Supplementary Notes 1 to 4, wherein

the data regarding the use condition of the communication device is remote network monitoring data (RMON data), and

the data analysis unit confirms an error rate included in the RMON data, and determines transmission power and/or a modulation scheme of the communication device to be monitored based on a result of the confirmation.

(Supplementary Note 6)

The control apparatus for a communication device according to any one of Supplementary Notes 1 to 5, wherein

the communication device to be monitored is controlled in the power saving mode in such a way that a threshold for an error rate is higher than a threshold for an error rate in the normal mode.

(Supplementary Note 7)

The control apparatus for a communication device according to any one of Supplementary Notes 1 to 6, further including:

a data storage that stores the data regarding the use condition of the communication device;

wherein the data acquisition unit acquires the data regarding the use condition of the communication device at regular intervals, and

the data analysis unit extracts a communication device with a low frequency of use among a plurality of the communication devices to be monitored and/or a time zone with a low frequency of use of the communication device from the data stored in the data storage.

(Supplementary Note 8)

The control apparatus for a communication device according to Supplementary Note 7, wherein

the device control unit controls the communication device to shift from the normal mode to the power saving mode with respect to the extracted communication device with the low frequency of use or in the extracted time zone with the low frequency of use of the communication device.

(Supplementary Note 9)

The control apparatus for a communication device according to Supplementary Note 8, wherein

the device control unit instructs the communication device to start the power saving mode, and instructs the communication device to release the power saving mode when a certain period of time elapses or when the power saving mode release time arrives.

(Supplementary Note 10)

The control apparatus for a communication device according to Supplementary Note 8, wherein

after the device control unit instructs the communication device under the power saving mode to temporarily release the power saving mode,

the data acquisition unit acquires real-time data regarding the use condition of the communication device that has shifted to the normal mode, and

the device control unit instructs the communication device that has shifted to the normal mode to restart the power saving mode based on an analysis result of the real-time data obtained by the data analysis unit.

(Supplementary Note 11)

The control apparatus for a communication device according to any one of Supplementary Notes 1 to 10, wherein

among the communication devices to be monitored, a communication device that opposes a communication device controlled to shift between the normal mode and the power saving mode in a wireless or wired manner is also controlled to shift between the normal mode and the power saving mode.

(Supplementary Note 12)

A communication system including:

the control apparatus for a communication device according to any one of Supplementary Notes 1 to 11; and

a communication device monitored by the control apparatus for a communication device.

(Supplementary Note 13)

A control method for a communication device, including:

acquiring data regarding a use condition of a communication device to be monitored from the communication device;

analyzing the use condition of the communication device to be monitored based on the acquired data regarding the use condition of the communication device; and

controlling the communication device to be monitored to shift between a normal mode and a power saving mode based on an analysis result of the use condition.

(Supplementary Note 14)

The control method for a communication device according to Supplementary Note 13, wherein

the communication device to be monitored is controlled in the power saving mode in such a way that transmission power is lower than transmission power in the normal mode.

(Supplementary Note 15)

The control method for a communication device according to Supplementary Note 13 or 14, wherein

the communication device to be monitored is controlled in the power saving mode in such a way as to adopt a modulation scheme different from a modulation scheme of communication in the normal mode.

(Supplementary Note 16)

The control method for a communication device according to any one of Supplementary Notes 13 to 15, wherein

the communication device to be monitored is controlled in the power saving mode in such a way as to turn off transmission power of one communication port out of a plurality of communication ports provided in the communication device.

(Supplementary Note 17)

The control method for a communication device according to any one of Supplementary Notes 13 to 16, wherein

the data regarding the use condition of the communication device is remote network monitoring data (RMON data),

the control method further including confirming an error rate included in the RMON data, and determining transmission power and/or a modulation scheme of the communication device to be monitored based on a result of the confirmation.

(Supplementary Note 18)

The control method for a communication device according to any one of Supplementary Notes 13 to 17, wherein

the communication device to be monitored is controlled in the power saving mode in such a way that a threshold for an error rate is higher than a threshold for an error rate in the normal mode.

(Supplementary Note 19)

The control method for a communication device according to any one of Supplementary Notes 13 to 18, further including:

acquiring and storing the data regarding the use condition of the communication device at regular intervals; and

extracting, from the stored data, a communication device with a low frequency of use among a plurality of the communication devices to be monitored and/or a time zone with a low frequency of use of the communication device.

(Supplementary Note 20)

The control method for a communication device according to Supplementary Note 19, further including

controlling the communication device to shift from the normal mode to the power saving mode with respect to the extracted communication device with the low frequency of use or in the extracted time zone with the low frequency of use of the communication device.

(Supplementary Note 21)

A control program for a communication device, the control program causing a computer to execute:

data acquisition processing of acquiring data regarding a use condition of a communication device to be monitored from the communication device;

data analysis processing of analyzing the use condition of the communication device to be monitored based on the acquired data regarding the use condition of the communication device; and

device control processing of controlling the communication device to be monitored to shift between a normal mode and a power saving mode based on an analysis result obtained by the data analysis processing.

(Supplementary Note 22)

The control program for a communication device according to Supplementary Note 21, wherein

the communication device to be monitored is controlled in the power saving mode in such a way that transmission power is lower than transmission power in the normal mode.

(Supplementary Note 23)

The control program for a communication device according to Supplementary Note 21 or 22, wherein

the communication device to be monitored is controlled in the power saving mode in such a way as to adopt a modulation scheme different from a modulation scheme of communication in the normal mode.

(Supplementary Note 24)

The control method for a communication device according to any one of Supplementary Notes 21 to 23, wherein

the communication device to be monitored is controlled in the power saving mode in such a way as to turn off transmission power of one communication port out of a plurality of communication ports provided in the communication device.

(Supplementary Note 25)

The control program for a communication device according to any one of Supplementary Notes 21 to 24, wherein

the data regarding the use condition of the communication device is remote network monitoring data (RMON data), and

the data analysis processing includes confirming an error rate included in the RMON data, and determining transmission power and/or a modulation scheme of the communication device to be monitored based on a result of the confirmation.

(Supplementary Note 26)

The control program for a communication device according to any one of Supplementary Notes 21 to 25, wherein

the communication device to be monitored is controlled in the power saving mode in such a way that a threshold for an error rate is higher than a threshold for an error rate in the normal mode.

(Supplementary Note 27)

The control program for a communication device according to any one of Supplementary Notes 21 to 26, wherein

the data acquisition processing includes acquiring and storing the data regarding the use condition of the communication device at regular intervals, and

the data analysis processing includes extracting, from the stored data, a communication device with a low frequency of use among a plurality of the communication devices to be monitored and/or a time zone with a low frequency of use of the communication device.

(Supplementary Note 28)

The control program for a communication device according to Supplementary Note 27, wherein

the device control processing includes controlling the communication device to shift from the normal mode to the power saving mode with respect to the extracted communication device with the low frequency of use or in the extracted time zone with the low frequency of use of the communication device.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A control apparatus for a communication device, comprising:
a data acquisition unit that acquires data regarding a use condition of a communication device to be monitored from the communication device;
a data analysis unit that analyzes the use condition of the communication device to be monitored based on the acquired data regarding the use condition of the communication device; and
a device control unit that controls the communication device to be monitored to shift between a normal mode and a power saving mode based on an analysis result obtained by the data analysis unit.

2. The control apparatus for a communication device according to claim 1, wherein
the communication device to be monitored is controlled in the power saving mode in such a way that transmission power is lower than transmission power in the normal mode.

3. The control apparatus for a communication device according to claim 1, wherein
the communication device to be monitored is controlled in the power saving mode in such a way as to adopt a modulation scheme different from a modulation scheme of communication in the normal mode.

4. The control apparatus for a communication device according to claim 1, wherein
the communication device to be monitored is controlled in the power saving mode in such a way as to turn off transmission power of one communication port among a plurality of communication ports provided in the communication device.

5. The control apparatus for a communication device according to claim 1, wherein
the data regarding the use condition of the communication device is remote network monitoring data (RMON data), and
the data analysis unit confirms an error rate included in the RMON data, and determines transmission power and/or a modulation scheme of the communication device to be monitored based on a result of the confirmation.

6. The control apparatus for a communication device according to claim 1, wherein
the communication device to be monitored is controlled in the power saving mode in such a way that a threshold for an error rate is higher than a threshold for an error rate in the normal mode.

7. The control apparatus for a communication device according to claim 1, further comprising:
a data storage that stores the data regarding the use condition of the communication device;
wherein the data acquisition unit acquires the data regarding the use condition of the communication device at regular intervals, and
the data analysis unit extracts a communication device with a low frequency of use among a plurality of the communication devices to be monitored and/or a time zone with a low frequency of use of the communication device from the data stored in the data storage.

8. The control apparatus for a communication device according to claim 7, wherein
the device control unit controls the communication device to shift from the normal mode to the power saving mode with respect to the extracted communication device with the low frequency of use or in the extracted time zone with the low frequency of use of the communication device.

9. A communication system comprising:
the control apparatus for a communication device according to claim 1; and
a communication device monitored by the control apparatus for the communication device.

10. A control method for a communication device, comprising:
acquiring data regarding a use condition of a communication device to be monitored from the communication device;
analyzing the use condition of the communication device to be monitored based on the acquired data regarding the use condition of the communication device; and
controlling the communication device to be monitored to shift between a normal mode and a power saving mode based on an analysis result of the use condition.

11. The control method for a communication device according to claim 10, wherein
the communication device to be monitored is controlled in the power saving mode in such a way that transmission power is lower than transmission power in the normal mode.

12. The control method for a communication device according to claim 10, wherein
the communication device to be monitored is controlled in the power saving mode in such a way as to adopt a modulation scheme different from a modulation scheme of communication in the normal mode.

13. The control method for a communication device according to claim 10, wherein
the communication device to be monitored is controlled in the power saving mode in such a way as to turn off transmission power of one communication port among a plurality of communication ports provided in the communication device.

14. The control method for a communication device according to claim 10, wherein
the data regarding the use condition of the communication device is remote network monitoring data (RMON data),
the control method further comprising confirming an error rate included in the RMON data, and determining transmission power and/or a modulation scheme of the communication device to be monitored based on a result of the confirmation.

15. The control method for a communication device according to claim 10, wherein
the communication device to be monitored is controlled in the power saving mode in such a way that a threshold for an error rate is higher than a threshold for an error rate in the normal mode.

16. The control method for a communication device according to claim 10, further comprising:
acquiring and storing the data regarding the use condition of the communication device at regular intervals; and
extracting, from the stored data, a communication device with a low frequency of use among a plurality of the communication devices to be monitored and/or a time zone with a low frequency of use of the communication device.

17. The control method for a communication device according to claim 16, further comprising
controlling the communication device to shift from the normal mode to the power saving mode with respect to the extracted communication device with the low frequency of use or in the extracted time zone with the low frequency of use of the communication device.

18. A non-transitory computer-readable control program for a communication device, the control program causing a computer to execute:
data acquisition processing of acquiring data regarding a use condition of a communication device to be monitored from the communication device;
data analysis processing of analyzing the use condition of the communication device to be monitored based on the acquired data regarding the use condition of the communication device; and
device control processing of controlling the communication device to be monitored to shift between a normal mode and a power saving mode based on an analysis result obtained by the data analysis processing.

19. The control program for a communication device according to claim 18, wherein
the communication device to be monitored is controlled in the power saving mode in such a way that transmission power is lower than transmission power in the normal mode.

20. The control program for a communication device according to claim 18, wherein
the communication device to be monitored is controlled in the power saving mode in such a way as to adopt a modulation scheme different from a modulation scheme of communication in the normal mode.
